(19) United States
(12) Patent Application Publication
(10) Pub. No.: US 2025/0220328 A1
(43) Pub. Date: Jul. 3, 2025

(54) LOUDSPEAKER BASKET

(71) Applicant: SAGEMCOM BROADBAND SAS, Bois-Colombes (FR)

(72) Inventors: Gilles BOURGOIN, Bois-Colombes (FR); Charles-Efflam MARTIN DE MONTAUDRY, Bois-Colombes (FR)

(21) Appl. No.: 19/007,953

(22) Filed: Jan. 2, 2025

(30) Foreign Application Priority Data
Jan. 3, 2024 (FR) FR2400031

(51) Int. Cl. H04R 1/02; H04R 1/28; H04R 7/18

(52) U.S. Cl. CPC H04R 1/025; H04R 1/2896; H04R 7/18; H04R 2400/11

(57) ABSTRACT

A frame of a loudspeaker is integrated into the sound box of a speaker enclosure and include a mobile assembly having a diaphragm. The frame includes a front face arranged to be positioned at a first face of the box and in which an opening is formed, defined by a periphery to which the diaphragm can be secured so that the diaphragm is in acoustic communication with the outside of the box via the opening. The frame further includes a fixing tab which extends from the front face of the frame towards the rear of the frame, and which is arranged to be fixed to a second face of the box.

The invention relates to the field of loudspeakers and, more specifically, to loudspeaker frames.

### PRIORT ART OF THE INVENTION

With reference to FIG. 1, a speaker enclosure 0 of the prior art, intended to be integrated into an audio equipment, comprises a sound box 1 comprising a rear shell 2 and a lid 3 forming a front face of the sound box 1. The rear shell 2 defines the internal acoustic volume of the speaker enclosure 0, which is closed by the lid 3.

The speaker enclosure 0 comprises a loudspeaker 4 integrated in the sound box 1. The loudspeaker 4 is fitted on the lid 3. The lid 3 comprises an opening 5, and the loudspeaker 4 is integrated in the box 1 so that its diaphragm 6 is in acoustic communication with the outside of the box 1 via the opening 5.

Sealing takes place between the rear shell 2 and the lid 3.

Yet, it is known that any mechanical part has natural modes of vibration, called eigenmodes. Each mode is associated with a specific deformation pattern and an eigen frequency, on which a tiny supply of energy will suffice to cause a resonance phenomenon. These modes depend on the mechanical characteristics of the materials used (density, stiffness, compressibility), the shape of the parts and their assembly (contact points, external stresses). They can lead to a deterioration of the acoustic performance of the speaker enclosure 0 by generating distortion or even vibrations audible to the user. They can also prematurely damage mechanical or electronic components by generating excessive stresses.

With regard to the box 1, the stiffness of the faces of the shell 2 is ensured by ribs 7 present on the inner walls of the shell 2. These ribs 7 are formed in the mould release direction of the shell 2. Likewise, the lid 3 may be stiffened by means of ribs or screws 8 fixing the lid 3 to the shell 2, such that the lid 3 is non-deformable in the direction of movement of the membrane 6 of the loudspeaker 4.

However, the loudspeaker 4 is not necessarily fitted on the lid 3 and can be fixed to a “side” face of the shell 2.

FIGS. 2 and 3 show a speaker enclosure 10 in which the loudspeaker 11 (only the frame is shown) is fixed, not to the lid 12, but to the top face 13 of the shell 14 of the box 15 defining the acoustic volume. By way of example, the choice of the positioning of the loudspeaker 11 results from mechanical and assembly constraints.

It is impossible to rib the upper face 13 in the direction of movement of the diaphragm of the loudspeaker 11 (not shown), since this would prevent the part from being removed from the mould. The addition of the mass of the magnet of the loudspeaker 11 cantilevered relative to its fasteners and the absence of reinforcements then modify the dynamic behaviour of the box 15 of the speaker enclosure 10: the eigenmodes of the latter lead to a significant displacement of the upper face 13 in the direction of movement of the diaphragm. The energy provided by the loudspeaker 11 is therefore, not negligible and these modes have a very high probability of being excited.

This arrangement therefore, risks leading to significant deformations.

This can be seen clearly in FIGS. 4 and 5. In these figures, the hatching represents the deformation levels: the tighter the hatching, the higher the levels.

The eigenmode of the box 15 of the speaker enclosure 10 has a maximum displacement corresponding to the vibration antinode 17 formed at the end of the upper face 13 on which the loudspeaker 11 is fixed, and on which the lid 12 rests, with a main component along the axis \vec{y}.

### AIM OF THE INVENTION

The aim of the invention is a solution making it possible to stiffen the faces of the box of a speaker enclosure incorporating a loudspeaker in order to limit the deformations of the latter during the operation of the loudspeaker.

### SUMMARY OF THE INVENTION

In order to achieve this object, a loudspeaker frame is provided, said loudspeaker being capable of being integrated into a sound box of a speaker enclosure and also being capable of comprising mobile assembly comprising a diaphragm, the frame comprising a front face arranged to be positioned at a first face of the sound box of the speaker enclosure and in which an opening defined by a periphery to which the diaphragm can be secured is formed, so that the diaphragm is in acoustic communication with the outside of the sound box of the speaker enclosure via the opening, the frame further comprising a fixing tab that extends from the front face of the frame towards the rear of the frame, and that is arranged to be fixed to a second face of the sound box of the speaker enclosure.

The fixing tab makes it possible to transfer, via the loudspeaker frame, the stiffness of the second face of the box of the speaker enclosure to the first face of the box of the speaker enclosure. Since the second face deforms very little along the axis of movement of the diaphragm of the loudspeaker, the deformations of the first face during operation of the loudspeaker are thus, very clearly limited.

A frame such as described above is also provided, in which the front face of the frame is arranged to be fixed to the first face of the sound box of the speaker enclosure.

A frame as described above is also provided, the frame being arranged to be fixed to the sound box of the speaker enclosure only via one or more fixing tabs which extend from the front face of the frame towards the rear of the frame and which are arranged to be fixed to one or more second faces of the sound box of the speaker enclosure.

A frame such as described above is also provided, in which the fixing tab has been formed by folding the front face over at least a portion of a length of an edge of the front face.

A frame as described above is also provided, in which the front face is folded over the entire length of said edge so that the fixing tab extends over all said length.

A frame as described above is also provided, in which an angle between a first plane in which the front face extends and a second plane in which the fixing tab extends is of between 60° and 120°.

A frame as described above is also provided, in which the fixing tab comprises a tapped hole for fixing it to the second face.

A loudspeaker is also provided, comprising a frame such as described above, and a mobile assembly comprising a diaphragm secured to the periphery of the opening of the front face of the frame.

A speaker enclosure is also provided, comprising a loudspeaker as described above and a sound box in which the loudspeaker is integrated, the sound box of the speaker enclosure comprising a first face and a second face, the diaphragm being in acoustic communication with the outside of the sound box via the opening, the fixing tab being fixed to the second face of the sound box of the speaker enclosure.

An audio equipment incorporating a speaker enclosure as described above is also provided.

An audio equipment as previously described is also provided, the audio equipment being a set-top box.

The invention shall be better understood in the light of the following description of a specific and non-limiting embodiment of the invention.

### BRIEF DESCRIPTION OF THE DRAWINGS

Reference will be made to the accompanying drawings, among which:

FIG. 1 is a side, perspective and cross-sectional view, along a plane parallel to a longitudinal axis of the loudspeaker, of a prior art speaker enclosure according to a first embodiment;

FIG. 2 is a side and perspective view of a prior art speaker enclosure according to a second embodiment;

FIG. 3 is a view similar to that of FIG. 2, but without the lid of the speaker enclosure;

FIG. 4 is a view similar to that of FIG. 2, which further illustrates the deformation of the box of the speaker enclosure according to one of its eigenmodes of deformation;

FIG. 5 is a figure similar to FIG. 3, also illustrating the deformation of the box of the speaker enclosure;

FIG. 6 is a perspective view of a first loudspeaker frame;

FIG. 7 is a perspective and cross-sectional view of a portion of the enclosure incorporating the loudspeaker frame of FIG. 6;

FIG. 8 is a section of a rectangular beam.

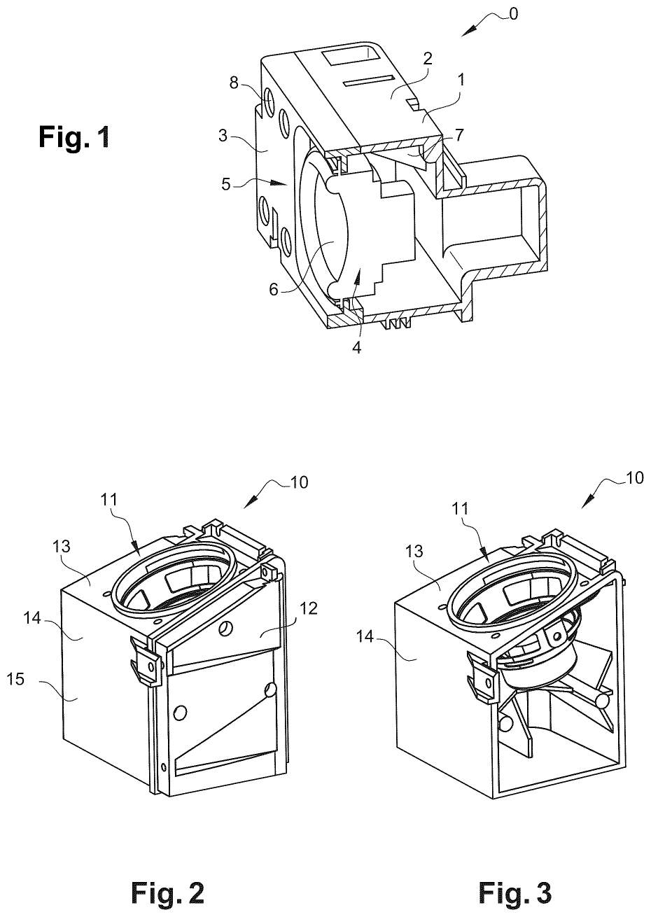

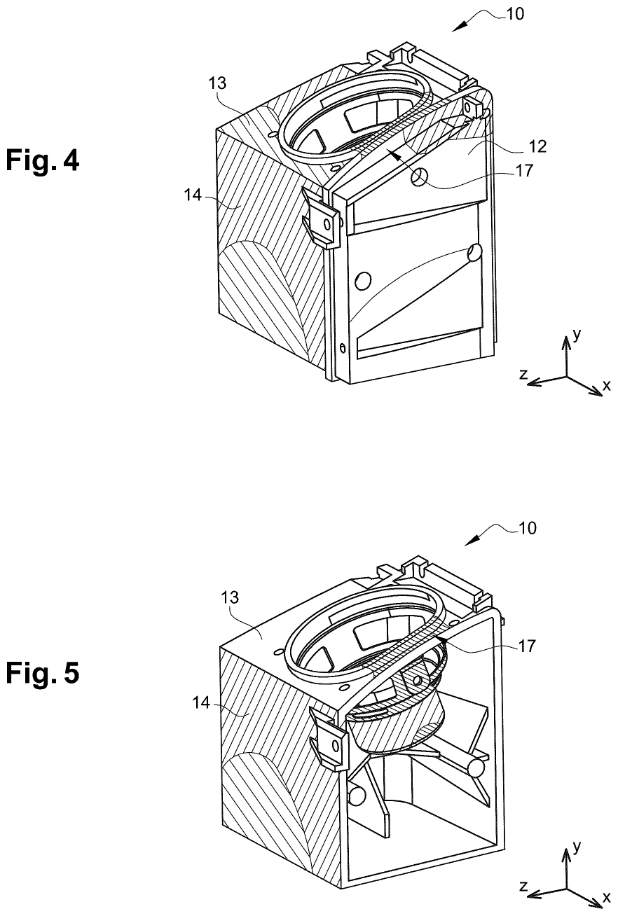

### DETAILED DESCRIPTION OF THE INVENTION

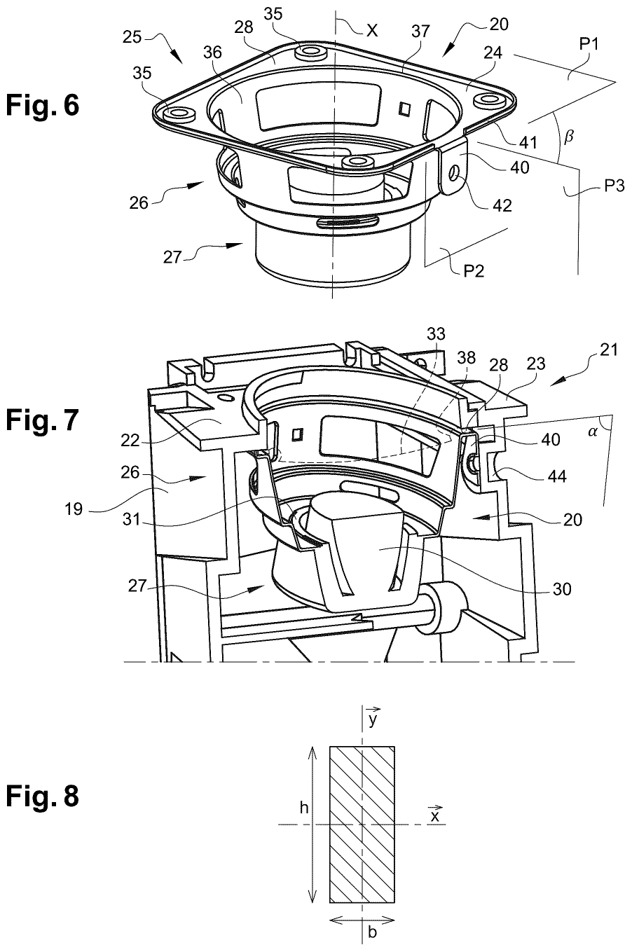

With reference to FIGS. 6 and 7, the loudspeaker 20 is integrated in the sound box 19 of an acoustic enclosure 21. The speaker enclosure 21 is intended to be integrated into an audio equipment (not shown), which is for example an enhanced set-top box, STB, capable of rendering audio signals.

The box 19 of the speaker enclosure 21 has a top face 22 and a lid 23 forming a rear face of the box 19 of the speaker enclosure 21.

The loudspeaker 20 comprises a frame 24. The term “basket” is also used to designate such a frame.

The frame 24, with a longitudinal axis X, comprises a front portion 25, a central portion 26 and a rear portion 27.

The front portion 25, with a generally flat shape, defines the front face 28 of the frame 24 which extends according to a first plane P1 perpendicular to the axis X.

It will be reminded that according to a common understanding in the related field, the expression “front face” refers to the totality of the plate 25 forming the front of the frame 24.

The central portion 26 is perforated and has a generally frustoconical shape with an axis X. The central portion 26 connects the front portion 25 and the rear portion 27.

The rear portion 27 is generally cylindrical in shape with an axis X and a circular section. The outer face of the bottom of the rear portion 27 defines the rear face of the frame 24.

The loudspeaker 20 also comprises a core 30 and a magnet 31 positioned in the rear portion 27 of the frame 24 of the loudspeaker 20.

The loudspeaker 20 also comprises a mobile assembly positioned in the frame 24. The mobile assembly comprises a diaphragm 33 (shown in dotted lines, in cross-section and in a very simplified manner) and a coil (not shown).

It will therefore, be understood that here, when talking about the loudspeaker 20 and the frame 24, the term “front” means on the side of the large diameter of the diaphragm 33 when the loudspeaker 20 is assembled, and the term “rear” means on the side of the magnet 31.

The front face 28 of the frame 24, is here intended in particular to fix the loudspeaker 20 on a first face of the box 19 of the speaker enclosure 21 in which the loudspeaker 20 is integrated. The first face is the top face 22.

The front face 28 of the frame 24, here made of sheet metal, is square in shape with rounded corners and comprises fixing means arranged to fix the front face 28 to the first face 22 of the box 19 of the speaker enclosure 21. In this example, the fixing means comprise four fixing holes 35, each positioned at a separate corner of the front face 28. The front face 28 also comprises a central opening 36 having the axis X as its central axis and defined by a circular periphery 37.

When the loudspeaker 20 is assembled, the diaphragm 33 of the loudspeaker 20 is secured, at its large diameter, to the periphery 37. More precisely, the diaphragm 33 is fixed to the periphery 37 by means of a peripheral suspension 38, which here has a toroidal shape. The periphery of the diaphragm 33, at its large diameter, therefore, extends into the opening 36 along the periphery 37, and the diaphragm 33 is in acoustic communication with the outside of the box 19 of the speaker enclosure 21 via the opening 36. When the loudspeaker 20 operates, the diaphragm 33 undergoes an X-axis displacement.

The frame 24 also comprises at least one fixing tab 40, in this case a single tab.

The fixing tab 40 extends from the front face 28 of the frame 24 towards the rear of the frame 24. More precisely, the fixing tab 40 extends from a central portion of an edge 41 of the front face 28 of the frame 24.

The fixing tab 40 lies in a second plane P2.

The angle α between the first plane P1 and the second plane P2 is for example, of between 60° and 120° and is here close to 90°.

The fixing tab 40 is made of bent sheet metal. The fixing tab 40 has been shaped by bending the front face 28 over a portion of a length of the edge 41 of the front face 28.

The fixing tab 40 comprises fixing means arranged to fix the fixing tab 40 to a second face of the box 19 of the speaker enclosure 21. In this case, the second face is the lid 23. In this case, the fixing means comprise a tapped hole 42.

The second face 23 therefore, meets the first face 22, for example, the box 19, inside which the acoustic volume of the speaker enclosure 21 is defined, has a ridge formed by an edge of the first face 22 and an edge of the second face 23.

A barrel 44 is formed in the lid 23, opposite which the tapped hole 42 of the fixing tab 40 is located when the loudspeaker 20 is integrated in the box 19 of the speaker enclosure 21. A screw extends in the barrel 44 and in the tapped hole 42 of the fixing tab 40 to fix the fixing tab 40 to the lid 23.

It should be noted that here, the angle α between the first plane P1 in which the front face 28 of the frame 24 extends, and the second plane P2 in which the fixing tab 40 extends, is equal to 90°. However, as explained above, the angle α can be other than 90°. It should be noted that the second plane P2, in which the fixing tab 40 extends, could also be oriented, with respect to the first plane P1, with a certain angle about an axis perpendicular to the plane P1 (here axis X).

The angle β between the first plane P1, and the third plane P3 which is perpendicular to the second plane P2 and which passes through a central axis of the tab 40 (said central axis passing through the end of the tab 40 which is fixed to the edge 41, and being parallel to the axis X in FIG. 6), may also be different from 90°.

The invention makes it possible to transfer the stiffness of the second face (lid 23) up to the first face 22 of the box 19 of the speaker enclosure 21 via the fixing tab 40 and the frame 24 of the loudspeaker 20.

The vibration antinode is therefore, mechanically linked to a fixed point in the main direction of movement \vec{y} of the first face 22.

It is known that the quadratic moment is representative of the resistance of an object to torsion or bending.

For a beam having a rectangular cross-section with a height h and a thickness b, such as that shown in FIG. 8, the quadratic moments with respect to the axes \vec{x} and \vec{y} are given respectively by the following formulae:

$${I}_{x} = \frac{b {h}^{3}}{12} and {I}_{y} = \frac{{b}^{3} h}{12} .$$

Thus, a beam with a large height h will have a Iₓ large quadratic moment and will deform very little along the axis\vec{y}. The second face 23 (lid) can be likened to a beam the height h of which is large compared to the thickness of the first face 22. The quadratic moment Iₓ of the second face 23 is consequent, such that, when the second face 23 is mechanically connected to the first face 22 by the addition of the fixing tab 40 on the frame 24, it acts as a rib and completely stiffens the first face 22 on which the frame 24 is fixed.

Naturally, the invention is not limited to the embodiment described but comprises any variant entering into the field of the invention, such as defined by the claims.

The fixing tab is not necessarily made of bent sheet metal. It may, for example, be an added tab, fixed by any type of means to the front face of the frame (by welding, for example).

The fixing tab may extend along the entire length of one side of the front face of the frame. If the fixing tab is formed by folding the front face, then the front face is folded over the entire length of the side and the fixing tab extends over the entire length of the side. The fixing tab then also acts as a rib.

The frame may include a plurality of fixing tabs, which extend from one or more edges of the front face. It should also be noted that the front face is not necessarily square or even rectangular, and that the fixing tab(s) can extend from any place on the front face (and not necessarily from an edge).

When the frame comprises a plurality of fixing tabs, they may be intended either to fix the frame to the same second face, or to a plurality of distinct second faces.

The loudspeaker frame may also be fixed to the box of the speaker enclosure only via one or more fixing tabs that are fixed to one or more second faces of the box of the speaker enclosure. In such a case, the front face of the frame no longer has the fixing holes and the front face is no longer fixed directly to the first face. This makes it possible to dispense with the presence of fixing points in the same plane as the diaphragm in order to solve design, assembly or industrialisation problems.

The first face, comprising the opening opposite which the diaphragm extends, and the second face, do not necessarily meet to form a ridge and are not necessarily adjacent faces. The second face can be any face of the box of the speaker enclosure other than the first face.

It should be noted that the invention is also applicable in the case where it is the frame of the loudspeaker which would have a vibration mode to be eliminated.

The speaker enclosure may comprise a sound box and an external cladding that are distinct from each other, or the sound box may have external faces that are arranged to constitute the external cladding of the speaker enclosure.

1. A frame of a loudspeaker, said loudspeaker being capable to be integrated into a sound box of a speaker enclosureand also being capable to comprise a mobile assembly comprising a diaphragm, the frame comprising a front face arranged to be positioned at a first face of the sound box of the speaker enclosure and in which an opening is formed, defined by a periphery to which the diaphragm can be secured so that the diaphragm is in acoustic communication with the outside of the sound box of the speaker enclosure via the opening, the frame furthermore, comprising a fixing tab that extends from the front face of the frame towards the rear of the frame, and that is arranged to be fixed to a second face of the sound box of the speaker enclosure.

2. The frame according to claim 1, wherein the front face of the frame is arranged to be fixed to the first face of the sound box of the speaker enclosure.

3. The frame according to claim 1, wherein the frame is arranged to be fixed to the sound box of the speaker enclosure only via one or more fixing tabs which extend from the front face of the frame towards the rear of the frame and which are arranged to be fixed to one or more second faces of the sound box of the speaker enclosure.

4. The frame according to claim 1, wherein the fixing tab has been formed by bending the front face over at least a portion of a length of an edge of the front face.

5. The frame according to claim 4, wherein the front face is folded over the entire length of said edge so that the fixing tab extends over all said length.

6. The frame according to claim 1, wherein an angle between a first plane in which the front face extends and a second plane in which the fixing tab extends is of between 60° and 120°.

7. The frame according to claim 1, wherein the fixing tab comprises a tapped hole for fixing it to the second face.

8. A loudspeaker comprising a frame according to claim 1, and a mobile assembly comprising a diaphragm secured to the periphery of the opening in the front face of the frame.

9. A speaker enclosure comprising a loudspeaker according to claim 8 and a sound box in which the loudspeaker is integrated, the sound box of the speaker enclosure comprising a first face and a second face, the diaphragm being in acoustic communication with the outside of the sound box via the opening, the fixing tab being fixed to the second face of the sound box of the speaker enclosure.

10. An audio equipment incorporating a speaker enclosure according to claim 9.

11. The audio equipment according to claim 10, wherein the audio equipment is a set-top box.
